(19) United States
(12) Patent Application Publication
(10) Pub. No.: US 2025/0252046 A1
(43) Pub. Date: Aug. 7, 2025

(54) CONTROL DEVICE, INFORMATION PROCESSING DEVICE, AND CONTROL METHOD

(71) Applicant: TOYOTA JIDOSHA KABUSHIKI KAISHA, Toyota-shi (JP)

(72) Inventor: Kenshi INOTANI, Nagakute-shi (JP)

(73) Assignee: TOYOTA JIDOSHA KABUSHIKI KAISHA, Toyota-shi (JP)

(21) Appl. No.: 18/969,893

(22) Filed: Dec. 5, 2024

(30) Foreign Application Priority Data
Feb. 2, 2024 (JP) 2024-014833

(51) Int. Cl. G06F 12/02

(52) U.S. Cl. CPC G06F 12/0246

(57) ABSTRACT

A control device for controlling an information storage device that is configured to store a plurality of bits of information in one cell, the control device including an execution unit configured to switch the information storage device to a second mode, on condition that a count of times that information is storable in the information storage device is smaller than a predetermined count of times, when the information storage device is in a first mode. The first mode is a mode in which multiple bits of information are stored in one cell, and the second mode is a mode in which one bit of information is stored in one cell.

### CROSS-REFERENCE TO RELATED APPLICATION

This application claims priority to Japanese Patent Application No. 2024-014833 filed on Feb. 2, 2024, incorporated herein by reference in its entirety.

### BACKGROUND

### 1. Technical Field

The present disclosure relates to a control device, an information processing device, and a control method.

### 2. Description of Related Art

Japanese Unexamined Patent Application Publication No. 2017-228010 (JP 2017-228010 A) describes an information processing device including an information storage device and a control device. The information storage device is capable of storage processing in a first mode in which a plurality of bits of information is stored in one cell. The information storage device is capable of storage processing in a second mode in which one bit of information is stored in one cell. The control device switches the storage mode of the information storage device from the first mode to the second mode on condition that a new storage device is connected to the information processing device.

### SUMMARY

In the information processing device such as that described in JP 2017-228010 A, the control device does not switch a storage mode of the information storage device from the first mode to the second mode unless a new storage device is connected. Accordingly, when the count of times of the information storage device storing information reaches an upper limit count of times that the information storage device can store information, the information storage device may become unable to store information.

An aspect of the present disclosure is a control device configured to control an information storage device that is configured to store a plurality of bits of information in one cell, the control device including an execution unit configured to switch the information storage device to a second mode, on condition that a count of times that information is storable in the information storage device is smaller than a predetermined count of times, when the information storage device is in a first mode, in which the first mode is a mode in which multiple bits of information are stored in one cell, and the second mode is a mode in which one bit of information is stored in one cell.

The execution unit may be configured to switch the information storage device to the second mode, on condition that the count of times that information is storable in the information storage device is smaller than the predetermined count of times and also a remaining capacity of the information storage device that is available is no smaller than a predetermined capacity, when the information storage device is in the first mode.

The execution unit may be configured to delete predetermined information stored in the information storage device when the count of times that information is storable in the information storage device is smaller than the predetermined count of times and also the remaining capacity of the information storage device that is available is smaller than the predetermined capacity, when the information storage device is in the first mode.

The execution unit may be configured to, following deleting the predetermined information, determine whether the remaining capacity of the information storage device that is available is smaller than the predetermined capacity.

The execution unit may be configured to output, to an output device, first information indicating a request to delete information stored in the information storage device, on condition that the count of times that information is storable in the information storage device is smaller than the predetermined count of times and also the remaining capacity of the information storage device that is available is smaller than the predetermined capacity, when the information storage device is in the first mode.

The execution unit may be configured to determine whether the remaining capacity of the information storage device that is available is smaller than the predetermined capacity when information stored in the information storage device is deleted by an operation from an input device, following outputting the first information to the output device.

The information storage device may include a plurality of regions for storing information, and the execution unit may be configured to switch storage modes of the regions individually.

An aspect of the present disclosure is an information processing device including an information storage device configured to store a plurality of bits of information in one cell; and a control device configured to control the information storage device, wherein the control device includes an execution unit and a storage unit, the storage unit is configured to store an operating system and an application that runs on the operating system. The execution unit is configured to store information in the information storage device in conjunction with execution of the application running on the operating system, and switch a storage mode of the information storage device to a second mode, on condition that a count of times that information is storable in the information storage device is smaller than a predetermined count of times, when the storage mode of the information storage device is a first mode at a time of updating the operating system, in which the first mode is a mode in which multiple bits of information are stored in one cell, and the second mode is a mode in which one bit of information is stored in one cell.

The information processing device may be installed in a vehicle. The operating system may be a first operating system, and a region of the information processing device that stores information in conjunction with execution of a first application running on the first operating system may be a first region. The first application may be a program that performs control different from traveling control of the vehicle. The execution unit may be configured to switch the first region to the second mode, on condition that a count of times that information is storable in the first region of the information storage device is smaller than a predetermined count of times, when the first region is in the first mode at a time of updating the first operating system.

The storage unit may be configured to store a second operating system different from the first operating system and a second application running on the second operating system. The second application may be a program that performs traveling control of the vehicle. The control device may be configured to store information in a second region of the information storage device that is different from the first region, in conjunction with execution of the second application, and switch the first region to the second mode without switching the second region to the second mode, on condition that the count of times that information is storable in the first region of the information storage device is smaller than the predetermined count of times, when the first region is in the first mode at the time of updating the first operating system.

An aspect of the present disclosure is a control method for controlling an information storage device that is configured to store a plurality of bits of information in one cell, the control method being executed by a computer and including switching the information storage device to a second mode on condition that a count of times that information is storable in the information storage device is smaller than a predetermined count of times, when the information storage device is in a first mode, in which the first mode is a mode in which multiple bits of information are stored in one cell, and the second mode is a mode in which one bit of information is stored in one cell.

An aspect of the present disclosure is a control program for controlling an information storage device that is configured to store a plurality of bits of information in one cell, the control program causing a computer to execute switching the information storage device to a second mode on condition that a count of times that information is storable in the information storage device is smaller than a predetermined count of times, when the information storage device is in a first mode, in which the first mode is a mode in which multiple bits of information are stored in one cell, and the second mode is a mode in which one bit of information is stored in one cell.

In each of the above configurations, when the information storage device is in the second mode, the remaining count of times that the information storage device can perform storing is greater than when the information storage device is in the first mode. According to each of the above configurations, the information storage device switches to the second mode on condition that the count of times the information can be stored in the information storage device is smaller than the predetermined count of times. This enables the information storage device to be suppressed from becoming unable to store information, more than when the information storage device is maintained in the first mode.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram of an information processing system; and

FIG. 2 is a flowchart showing a series of processing including mode switching.

### DETAILED DESCRIPTION OF EMBODIMENTS

### Embodiment

An embodiment of a control device for a storage device, an information processing device, a control method for the storage device, and a control program for the storage device will be described below.

### Overview of Information Processing System

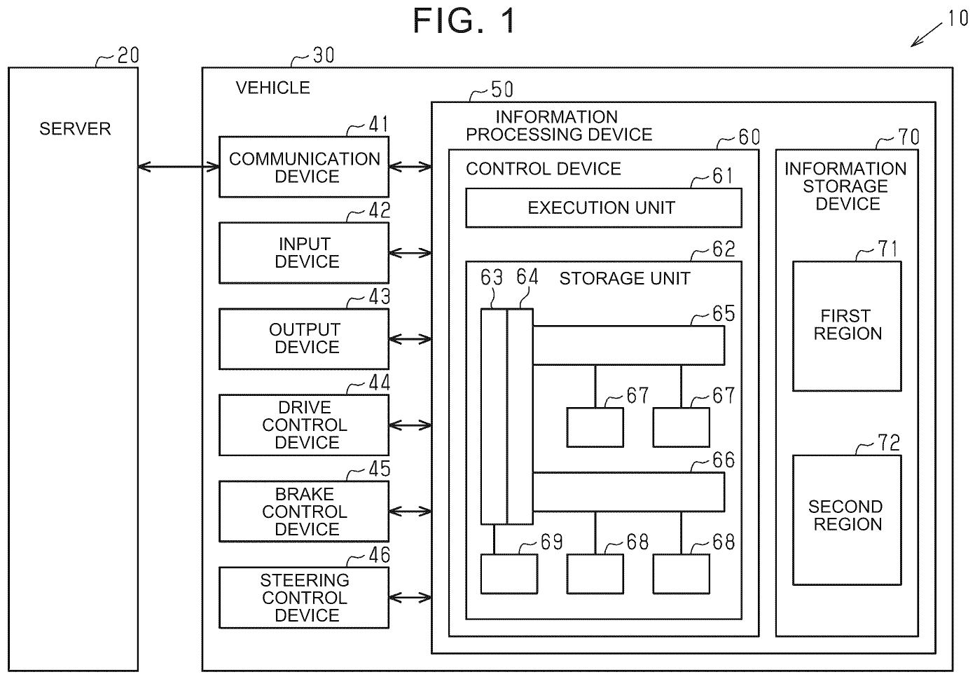

As illustrated in FIG. 1, an information processing system 10 includes a server 20 and a vehicle 30. The server 20 is capable of wireless communication with the vehicle 30 via a wireless communication network that is omitted from illustration. The server 20 acquires vehicle configuration information indicating a state of software of the vehicle 30 from the vehicle 30. Based on the vehicle configuration information of the vehicle 30 that is acquired, the server 20 transmits campaign information to the vehicle 30, indicating that a software update is available. Also, the server 20 transmits information indicating update software in response to a request from the vehicle 30. The information indicating the update software is, for example, information indicating the software following the update.

The vehicle 30 is equipped with a communication device 41, an input device 42, an output device 43, a drive control device 44, a brake control device 45, a steering control device 46, and an information processing device 50. That is to say, the information processing device 50 is installed in the vehicle 30.

The communication device 41 is capable of wireless communication with the server 20 via the wireless communication network that is omitted from illustration. The communication device 41 outputs the information that is acquired from the server 20 to the information processing device 50. The communication device 41 transmits the information acquired from the information processing device 50 to the server 20 via wireless communication.

The input device 42 is a device into which a signal indicating a content of an operation is input by an operation performed by a user. The output device 43 outputs information, indicating a signal input from the information processing device 50, as an image or sound. The output device 43 outputs images and sounds so as to, for example, request the user to operate the input device 42. When the user operates the input device 42, the input device 42 inputs a signal indicating the content of the operation to the information processing device 50. The input device 42 and the output device 43 are realized, for example, as a touchscreen display.

The drive control device 44 is a device that controls a drive source of the vehicle 30. The drive source is, for example, an internal combustion engine and a motor. The drive control device 44 controls the drive source based on user operations of an accelerator pedal or the like, thereby controlling driving of the vehicle 30. Also, the drive control device 44 adjusts control of the internal combustion engine based on information indicating a signal input from the information processing device 50. For example, when information indicating a traveling mode of the vehicle 30, such as a sports mode or the like, is input from the information processing device 50, the drive control device 44 adjusts drive content of the vehicle 30 in accordance with the input mode.

The brake control device 45 is a device that controls brakes of the vehicle 30. The brake control device 45 controls braking of the vehicle 30 by controlling the brakes based on user operations of a brake pedal or the like. Also, the brake control device 45 adjusts brake control based on information indicating a signal input from the information processing device 50. For example, when information indicating the traveling mode of the vehicle 30 is input from the information processing device 50, the brake control device 45 adjusts the braking content of the vehicle 30 in accordance with the mode that is input.

The steering control device 46 is a device that controls a steering device of the vehicle 30. The steering control device 46 controls the steering device based on user operations of a steering wheel, thereby controlling a steering angle of the vehicle 30. Also, the steering control device 46 adjusts the control of the steering device based on information indicating a signal input from the information processing device 50. For example, when information indicating the traveling mode of the vehicle 30 is input from the information processing device 50, the steering control device 46 adjusts the steering angle of the vehicle 30 in accordance with the mode that is input.

The information processing device 50 is a device that processes information regarding the vehicle 30. The information processing device 50 acquires the information received from the communication device 41 by the server 20. The information processing device 50 outputs, to the communication device 41, information to be transmitted to the server 20. The information processing device 50 acquires a signal indicating content of a user operation from the input device 42. The information processing device 50 outputs a signal representing an image or sound to the output device 43. The information processing device 50 outputs information indicating the traveling mode of the vehicle 30 to the drive control device 44, the brake control device 45, and the steering control device 46.

The information processing device 50 includes a control device 60 and an information storage device 70. The control device 60 controls a storage mode of the information storage device 70. The control device 60 is a computer having an execution unit 61 and a storage unit 62. The execution unit 61 is a central processing unit (CPU). The storage unit 62 is read only memory (ROM) and random access memory (RAM). The storage unit 62 stores various programs in which the processing to be executed by the execution unit 61 is described. The execution unit 61 may be made up of one or more processors. The storage unit 62 may be made up one or more memory devices.

The storage unit 62 stores a management operating system 63, a hypervisor 64, a first operating system 65, and a second operating system 66. The hypervisor 64 is software that constructs a virtualized environment in which a plurality of operating systems can run. The hypervisor 64 runs on the management operating system 63.

The first operating system 65 and the second operating system 66 run on the hypervisor 64. Accordingly, the first operating system 65 and the second operating system 66 can be executed in parallel by the execution unit 61. That is to say, the execution unit 61 runs the management operating system 63, and thereupon executes the first operating system 65 and the second operating system 66 in parallel. Thus, the first operating system 65 and the second operating system 66 run. The hypervisor 64 minimizes the exchange of information between the first operating system 65 and the second operating system 66 such that these operating systems do not interfere with each other.

The storage unit 62 stores a plurality of first applications 67 which are application programs for the first operating system 65. The first applications 67 run on the first operating system 65. Accordingly, the first applications 67 are executed by the execution unit 61 on the first operating system 65 in a state in which the first operating system 65 is being executed. The first applications 67 are programs that perform control other than traveling control of the vehicle 30. For example, the first applications 67 are a program that controls the output device 43 to realize a chat function, a program that controls the output device 43 to realize a call function, and a program that controls the output device 43 to realize a function for displaying information, such as a weather forecast or the like. In other words, the first applications 67 are programs that perform control other than traveling control, which includes drive control, braking control, and steering angle control of the vehicle 30. Note that two first applications 67 are illustrated in FIG. 1.

The storage unit 62 stores a plurality of second applications 68 which is application programs for the second operating system 66. The second applications 68 run on the second operating system 66. Accordingly, the second applications 68 are executed by the execution unit 61 on the second operating system 66 in a state in which the second operating system 66 is being executed. The second applications 68 are programs that perform traveling control of the vehicle 30. For example, the second applications 68 are programs that output the traveling mode of the vehicle 30 to the drive control device 44, the brake control device 45, and the steering control device 46. Also, for example, the second applications 68 are a program that adjusts the control content for the drive control device 44, a program that adjusts the control content for the brake control device 45, and a program that adjusts the control content for the steering control device 46. Note that two second applications 68 are illustrated in FIG. 1.

The storage unit 62 stores a control program 69 to control the storage mode of the information storage device 70, for the management operating system 63. The control program 69 is a program that realizes a control method for controlling the storage mode of the information storage device 70. The control program 69 runs on the management operating system 63. Accordingly, the control program 69 is executed by the execution unit 61 on the management operating system 63, in a state in which the management operating system 63 is being executed.

The information storage device 70 stores information by various types of programs in the control device 60 being executed. The information storage device 70 is capable of storing multiple bits of information in one cell. The information storage device 70 is NAND type flash memory. The information storage device 70 is, for example, an eMMC (embedded MultiMediaCard).

The information storage device 70 has a first region 71 and a second region 72 as regions for storing information. The first region 71 is a region capable of storing information in conjunction with the execution of the first operating system 65. The second region 72 is a region capable of storing information in conjunction with the execution of the second operating system 66.

The information storage device 70 stores information for each region in the storage mode that is set. The information storage device 70 can set the storage mode for each region to a first mode or a second mode. The first mode is a mode in which multiple bits of information are stored in one cell. The first mode is, for example, a multi-level cell (MLC) mode. The second mode is a mode in which one bit of information is stored in one cell. The second mode is, for example, a pseudo single-level cell (pSLC) mode. The storage mode of the information storage device 70 at the point in time of shipping is the first mode for both the first region 71 and the second region 72.

The execution unit 61 stores information in the first region 71 of the information storage device 70 in conjunction with execution of the first operating system 65. At this time, the execution unit 61 counts the count of times information is stored in conjunction with the first operating system 65 being executed. The execution unit 61 stores a count value that is counted in the first region 71 of the information storage device 70 as the count of times the information has been stored in the first region 71.

The execution unit 61 stores information in the second region 72 of the information storage device 70 in conjunction with execution of the second operating system 66. At this time, the execution unit 61 counts the count of times information is stored in conjunction with the second operating system 66 being executed. The execution unit 61 stores the count value that is counted in the second region 72 of the information storage device 70 as the count of times the information has been stored in the second region 72.

The count of times information is stored corresponds to the count of times information is written to the same memory cell in conjunction with the execution of an application. The storage of information here includes not only writing information to an empty memory cell, but also overwriting stored contents of a memory cell to which information has already been written. Note that the information storage device 70 stores the count of times that information has been stored since the point in time of shipping of the information storage device 70. That is to say, the execution unit 61 updates, on the fly, the count of times of information being stored, that is saved in the information storage device 70. Accordingly, the count of times of information being stored is a value that increases with use of this information storage device 70.

The execution unit 61 executes the first applications 67 to realize functions of the first applications 67. As described above, the execution unit 61 executes the first applications 67 on the first operating system 65. Accordingly, the execution unit 61 is also executing the first operating system 65 in conjunction with the execution of the first applications 67, and thus information in conjunction with the execution of the first applications 67 is stored in the first region 71.

The execution unit 61 executes the second applications 68 to realize functions of the second applications 68. The execution unit 61 executes the second applications 68 on the second operating system 66. The execution unit 61 is also executing the second operating system 66 in conjunction with the execution of the second applications 68, and thus information associated with the execution of the second applications 68 is stored in the second region 72.

The information storage device 70 stores a first upper limit count of times and a second upper limit count of times in advance. The first upper limit count of times is an upper limit count of times that the first operating system 65 can store in the first region 71. The first upper limit count of times is a value that is set in advance for each storage mode. The second upper limit count of times is an upper limit count of times that the second operating system 66 can store in the second region 72. The second upper limit count of times is a value that is determined in advance for each storage mode. For example, the first upper limit count of times and the second upper limit count of times in the first mode are set as follows. First, the total upper limit count of times that information can be stored in the information storage device 70 in the first mode is acquired. Note that the total upper limit count of times is the count of times that writing can be performed to one memory cell or a predetermined memory frame in the first mode. The total upper limit count of times is a count set depending on, for example, the type of the information storage device 70, or the like. Accordingly, a total capacity of information that can be stored in the information storage device 70 in the first mode, including overwriting of information, is a value obtained by multiplying the total upper limit count of times by the capacity of the memory cell or the memory frame, and the count of memory cells or the memory frames. Next, a usage ratio between the first operating system 65 and the second operating system 66 is set. Values in accordance with the usage ratio of the total upper limit count of times are set as the first upper limit count of times and the second upper limit count of times in the first mode.

### Series of Processing Including Mode Switching

When the execution unit 61 acquires information indicating update software from the server 20 via the communication device 41 when the first region 71 is set to the first mode, the execution unit 61 executes the control program 69.

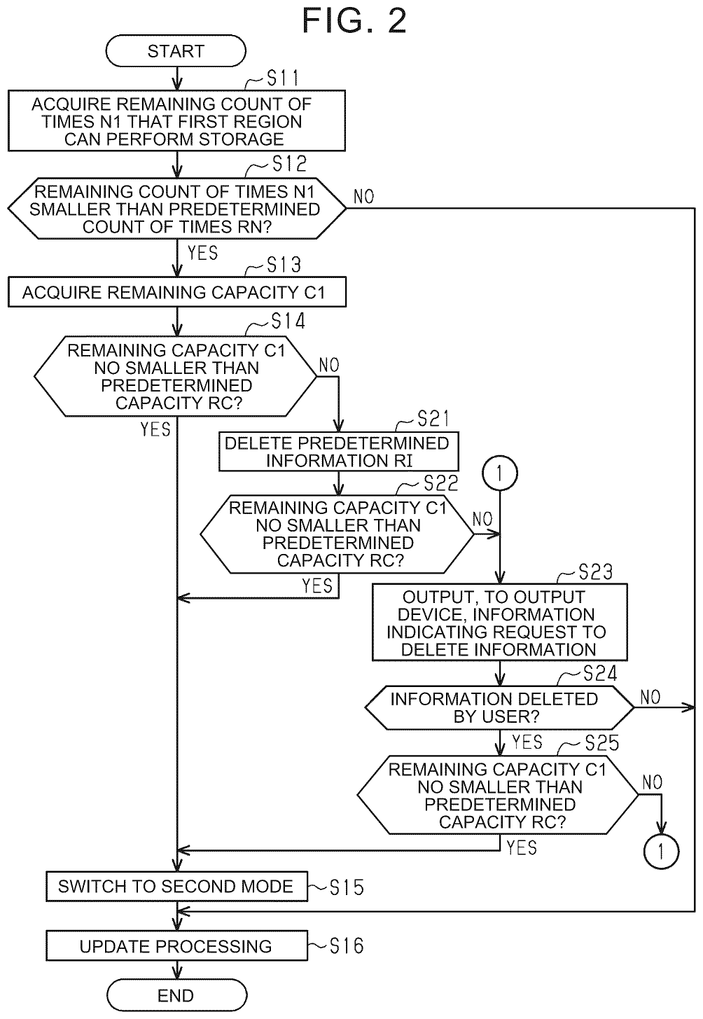

As shown in FIG. 2, when starting executing the control program 69, the execution unit 61 first performs processing of step S11.

In step S11, the execution unit 61 acquires a remaining count of times N1 regarding which storage can be performed in the first region 71. Specifically, the execution unit 61 acquires the remaining count of times N1 by subtracting the count of times stored in the first region 71 from the first upper limit count of times. That is to say, the remaining count of times N1 is a value that decreases as the information storage device 70 is used. The execution unit 61 then advances the processing to step S12.

In step S12, the execution unit 61 determines whether the remaining count of times N1 is smaller than a predetermined count of times RN set in advance. The predetermined count of times RN is determined in advance through testing, simulation, or the like, as a count that is smaller than the first upper limit count of times, but indicates that the remaining count of times that can be stored has become correspondingly small. When the remaining count of times N1 is smaller than the predetermined count of times RN (YES in S12), the execution unit 61 advances the processing to step S13.

In step S13, the execution unit 61 acquires the remaining capacity C1 of the first region 71 that is available. Specifically, the execution unit 61 acquires information indicating which regions of the first region 71 are in use and which regions are not in use. Next, the execution unit 61 acquires the total value of the memory cells or memory frames in the unused regions of the first region 71 as the remaining capacity C1. Note that the expression “using a region” means that an installed program is occupying the region. In other words, the more programs that are installed, the more regions will be used. The execution unit 61 then advances the processing to step S14.

In step S14, the execution unit 61 determines whether the remaining capacity C1 is no smaller than a predetermined capacity RC. The predetermined capacity RC is determined in advance through tests, simulations, and so forth, as a capacity required for the first region 71, in order to switch the first region 71 from the first mode to the second mode. When the remaining capacity C1 is no smaller than the predetermined capacity RC (YES in S14), the execution unit 61 advances the processing to step S15.

In step S15, the execution unit 61 switches the first region 71 from the first mode to the second mode. That is to say, the execution unit 61 switches the first region 71 from the first mode to the second mode on condition that the remaining count of times N1 is smaller than the predetermined count of times RN and the remaining capacity C1 is no smaller than the predetermined capacity RC. In the present embodiment, the execution unit 61 switches the storage mode of the first region 71 from MLC to pSLC. The execution unit 61 can switch the storage modes of the multiple regions of the information storage device 70 individually. The execution unit 61 then advances the processing to step S16.

In step S16, the execution unit 61 performs update processing for the first operating system 65, based on information indicating update software that is downloaded. Specifically, the execution unit 61 installs information indicating the software following updating in the storage unit 62. Thereafter, the execution unit 61 performs activation based on the information indicating the software following updating that is installed. Thus, the execution unit 61 can execute the first operating system 65 following updating, based on the information indicating the software following updating. Thereafter, the execution unit 61 ends the series of processing.

When the remaining count of times N1 is no smaller than the predetermined count of times RN (NO in S12), the execution unit 61 advances the processing to step S16.

That is to say, when the remaining count of times N1 is no smaller than the predetermined count of times RN, the execution unit 61 performs the update processing of the first operating system 65 while maintaining the first region 71 in the first mode, without switching to the second mode.

When the remaining capacity C1 is smaller than the predetermined capacity RC (NO in S14), the execution unit 61 advances the processing to step S21. In step S21, the execution unit 61 deletes the predetermined information RI in the first region 71. The predetermined information RI is set in advance through testing and simulation, as information that will not affect subsequent control even when deleted, such as log information from a predetermined period of time or more in the past, or the like. The execution unit 61 then advances the processing to step S22.

In step S22, the execution unit 61 determines whether the remaining capacity C1 is no smaller than the predetermined capacity RC. That is to say, following deleting the predetermined information RI, the execution unit 61 determines whether the remaining capacity C1 is no smaller than the predetermined capacity RC. In the present embodiment, the processing of step S22 is the same as the processing of step S14. When the remaining capacity C1 is no smaller than the predetermined capacity RC (YES in S22), the execution unit 61 advances the processing to step S15.

When the remaining capacity C1 is smaller than the predetermined capacity RC (NO in S22), the execution unit 61 advances the processing to step S23.

In step S23, the execution unit 61 outputs, to the output device 43, a request to output information indicating a request to the user, to delete information from the first region 71. Thus, the output device 43 outputs a request to the user to delete information from the first region 71 by an image including text, for example. Specifically, the output device 43 displays an image including text stating, “1 GB more of data needs to be deleted in order to switch to SLC.” The execution unit 61 then advances the processing to step S24.

In step S24, the execution unit 61 determines whether information in the first region 71 has been deleted by the user. For example, when the execution unit 61 acquires information indicating an operation in which the user has completed deleting information from the first region 71 from the input device 42, the execution unit 61 determines that information in the first region 71 has been deleted by the user. Also, when the execution unit 61 does not acquire, within a predetermined period of time, information indicating an operation by the user from the input device 42 indicating that the deletion of the information from the first region 71 has been completed, the execution unit 61 determines that the information in the first region 71 has not been deleted by the user. When the information in the first region 71 has not been deleted by the user (NO in S24), the execution unit 61 advances the processing to step S16. When the information in the first region 71 has been deleted by the user (YES in S24), the execution unit 61 advances the processing to step S25.

In step S25, the execution unit 61 determines whether the remaining capacity C1 is no smaller than the predetermined capacity RC. That is to say, when outputting information indicating a request to delete information to the output device 43, and thereafter information is deleted by an operation from the input device 42, the execution unit 61 determines whether the remaining capacity C1 is no smaller than the predetermined capacity RC. In the present embodiment, the processing of step S25 is the same as the processing of step S14. When the remaining capacity C1 is no smaller than the predetermined capacity RC (YES in S25), the execution unit 61 advances the processing to step S15. When the remaining capacity C1 is smaller than the predetermined capacity RC (NO in S25), the execution unit 61 returns the processing to step S23. Thus, the execution unit 61 again outputs information to the output device 43, indicating a request to delete information.

### Effects of Embodiment

A storage count of times that storage can be performed when the storage mode of the first region 71 is the second mode is approximately ten times the storage count of times that storage can be performed when the storage mode of the first region 71 is the first mode. According to the above embodiment, in step S15, the execution unit 61 switches the first region 71 from the first mode to the second mode. Thus, the storage mode of the first region 71 of the information storage device 70 is switched from the first mode to the second mode, and the remaining storage count of times that storage can be performed in the first region 71 increases by approximately ten times.

### Advantages of Embodiment

According to the above embodiment, when the count of times that the first region 71 of the information storage device 70 can store information falls below the predetermined count of times RN, the mode is switched to the second mode, and the remaining count of times N1 that the information storage device 70 can perform storage becomes greater than that when remaining in the first mode. Thus, the information storage device 70 can be suppressed from becoming unable to store information.

According to the above embodiment, on condition that the count of times that the first region 71 can store information falls below the predetermined count of times RN, and further the remaining capacity C1 is no smaller than the predetermined capacity RC, the execution unit 61 switches the storage mode of the information storage device 70 to the second mode. Thus, switching of the storage mode can be suppressed from being delayed midway.

According to the above embodiment, when the count of times that the first region 71 can store information becomes smaller than the predetermined count of times RN, and further the remaining capacity C1 is smaller than the predetermined capacity RC, the execution unit 61 deletes the predetermined information RI. Thus, the remaining capacity C1 increases. Accordingly, by deleting the predetermined information RI, the remaining capacity C1 may become no smaller than the predetermined capacity RC.

According to the above embodiment, following deleting the predetermined information RI, the execution unit 61 determines whether the remaining capacity C1 is smaller than the predetermined capacity RC. Thus, whether to switch to the second mode can be determined based on the remaining capacity C1 that has increased as a result of deleting the predetermined information RI compared to before the deletion.

According to the above embodiment, when the remaining count of times N1 becomes smaller than the predetermined count of times RN, and further the remaining capacity C1 is smaller than the predetermined capacity RC, the execution unit 61 outputs a request to the output device 43, to output information indicating a request to the user to delete information in the first region 71. Thus, the user can be prompted to delete information in the first region 71. As a result, due to a deletion operation being performed by the user, the remaining capacity C1 may become no smaller than the predetermined capacity RC.

According to the above embodiment, when a request to output information indicating a request to delete information is output to the output device 43, and thereafter the information is deleted by an operation from the input device 42, the execution unit 61 determines whether the remaining capacity C1 is smaller than the predetermined capacity RC. Accordingly, whether to switch to the second mode can be determined based on the remaining capacity C1 that has increased as a result of the user performing the deletion operation, as compared to before the deletion operation.

According to the above embodiment, at a time of updating the first operating system 65, the execution unit 61 switches the storage mode, in which information is stored in conjunction with the execution of the first operating system 65, to the second mode. Accordingly, the timing of switching the storage mode matches the timing of updating the first operating system 65. In this case, the user is less likely to sense switching of the storage mode as being unnatural.

According to the above embodiment, the object regarding which the storage mode is switched by the execution unit 61 is the first region 71 of the information storage device 70. The first region 71 is a region in which information is stored in conjunction with the first applications 67 being executed. The first applications 67 are programs that perform control other than traveling control of the vehicle 30. According to the above embodiment, the execution unit 61 switches the storage mode of the first region 71 to the second mode at the time of updating the first operating system 65. Accordingly, due to the change from the update of the first operating system 65 and the change in the storage mode of the first region 71 occurring at the same time, the user can be suppressed from feeling as if the change is occurring twice.

When the storage mode of the information storage device 70 is switched from the first mode to the second mode, the available capacity is reduced to approximately one-third. In the above embodiment, the second region 72 stores information in conjunction with execution of the second applications 68. The second applications 68 are programs that perform traveling control of the vehicle 30. According to the above embodiment, at the time of updating the first operating system 65, the execution unit 61 switches the storage mode of the first region 71 to the second mode without switching the storage mode of the second region 72 to the second mode. With regard to the second region 72, the capacity for use does not drop to one-third by switching to the second mode, and accordingly a situation in which traveling control can no longer be performed due to a shortage of capacity for use, caused by traveling control being performed, can be circumvented.

### OTHER EMBODIMENTS

The above embodiment can be carried out modified as follows. The above embodiment and the following modifications can be carried out combined as long as no technical contradiction arises.

### Regarding Information Processing Device

The control device 60 may be configured as circuitry including one or more processors that execute various types of processing in accordance with computer programs (software). Note that the control device 60 may be configured as circuitry including one or more dedicated hardware circuits, such as an application-specific integrated circuit (ASIC) or the like, that execute at least part of the various types of processing, or a combination thereof. The processor includes a CPU, and memory such as RAM, ROM, or the like. The memory stores program codes or commands configured to cause the CPU to execute processing. The memory, i.e., a computer-readable medium, includes any usable media that can be accessed by a general-purpose or dedicated computer.

The storage unit 62 may be included in the information storage device 70. The information processing device 50 may be made up of the execution unit 61, and the information storage device 70 including the storage unit 62. That is to say, the information storage device 70 may have a storage region that is divided into a program storage region for storing programs and a data storage region for storing data that is stored in conjunction with the execution of the programs. In this case, the program storage region makes up the storage unit 62, and the data storage region makes up the first region 71 and the second region 72 in the above embodiment.

The storage unit 62 does not need to have the two operating systems of the first operating system 65 and the second operating system 66. For example, the second operating system 66 may be omitted. In this case, the information processing device 50 functions as a device that performs control other than traveling control of the vehicle 30.

The information processing device 50 does not have to be installed in the vehicle 30.

The information storage device 70 does not need to have the storage region thereof divided into the first region 71 and the second region 72. Specifically, the information storage device 70 may use storage regions regardless of the operating systems and the applications executed by the execution unit 61.

### Regarding Series of Processing Including Mode Switching

The time of updating the first operating system 65, which is the timing of the execution unit 61 executing the control program 69, is not limited to the time when information indicating the update software is received. For example, this may be at a time when the campaign information is received, or at a time when information, indicating the updated software, is installed. Any time will suffice as long as between when the campaign information is received and when activation is complete.

The timing at which the execution unit 61 executes the control program 69 is not limited to the time at which the first operating system 65 is updated. For example, the execution unit 61 may execute the control program 69 at the time of starting the vehicle 30.

The execution unit 61 may switch the storage mode of the information storage device 70 based on the total storage count of times in the first region 71 and in the second region 72. In this case, the execution unit 61 may switch the storage mode of the entire storage region of the information storage device 70, not just the first region 71 which is a part of the information storage device 70 as in the above embodiment.

The execution unit 61 may perform the processing of steps S21 and S22 following the processing of step S25. That is to say, the execution unit 61 may first request the user to delete information, and thereafter delete the predetermined information RI.

The execution unit 61 may perform the processing of step S15 simultaneously with the processing of step S16, or may perform the processing of step S15 following the processing of step S16.

Regarding the processing of steps S11 and S12, it is sufficient for the execution unit 61 to determine whether the remaining count of times N1 is smaller than the predetermined count of times RN, and the detailed processing is not limited to the example of the above embodiment. For example, the execution unit 61 may determine whether the remaining count of times N1 is smaller than the predetermined count of times RN depending on whether the storage count of times of the information in the first region that is counted exceeds a count of times obtained by subtracting the predetermined count of times RN from the first upper limit count of times.

Regarding the processing of steps S13 and S14, it is sufficient for the execution unit 61 to determine whether the remaining capacity C1 is no smaller than the predetermined capacity RC, and the detailed processing is not limited to the example of the above embodiment. For example, the execution unit 61 may calculate the capacity for use based on information indicating the region that is used in the first region, and then determine whether the capacity for use that is calculated is smaller than a capacity obtained by subtracting the predetermined capacity from the total capacity. The execution unit 61 may thus determine whether the remaining capacity C1 is no smaller than the predetermined capacity RC.

In the processing of step S14, the execution unit 61 may select information to be deleted based on the result of comparing the remaining capacity C1 with the predetermined capacity RC. Specifically, the execution unit 61 may select the type of information that satisfies a deletion capacity that is necessary.

Following the processing of step S12, the execution unit 61 may perform the processing of step S21 and thereafter the processing of step S13. In this case, the execution unit 61 may omit the processing of step S22, and advance the processing to step S23 when a negative determination is made in the processing of step S14. This enables the remaining capacity C1 to be compared with the predetermined capacity RC after the predetermined information RI has been deleted in advance.

Out of the series of processing shown in FIG. 2, the execution unit 61 may omit step S14 and advance the processing to step S21 following the processing of step S13. In this case, when the determination of the processing in step S12 is affirmative and also the determination of the processing in step S22 is affirmative, a determination of switching can be made based on the count of times that storing can be performed and the available capacity.

The execution unit 61 may omit the processing of step S25 out of the series of processing shown in FIG. 2. The execution unit 61 may deem the remaining capacity C1 to have become sufficiently great as a result of the processing in step S24.

The execution unit 61 may omit the processing of step S22 out of the series of processing shown in FIG. 2. In this case, for example, the execution unit 61 can advance the processing to step S23 following the processing of step S21.

The execution unit 61 may omit the processing of steps S21 and S22 out of the series of processing shown in FIG. 2. In this case, when making a negative determination in the processing of step S14, the execution unit 61 can advance the processing to step S23.

The execution unit 61 may omit the processing of steps S23 to S25 out of the series of processing shown in FIG. 2. In this case, when making a negative determination in the processing of step S22, the execution unit 61 can thereafter advance the processing to step S16.

The execution unit 61 may omit the processing of steps S21 to S25 out of the series of processing shown in FIG. 2. In this case, when making a negative determination in the processing of step S14, the execution unit 61 can thereafter advance the processing to step S16.

In the series of processing shown in FIG. 2, the processing of steps S13, S14, and S21 to S25 may be omitted. When making an affirmative determination in step S12, the execution unit 61 can perform the processing of step S15.

The execution unit 61 may perform the processing of step S15 when acquiring a result of positive determination in step S12 from another device. In this case, in is sufficient for the other device to perform the processing of step S12 and also output the determination result of step S12 to the control device, and the execution unit 61 to acquire the determination result of the processing of step S12 from this other device.

### Others

The first mode is not limited to MLC mode, and may be triple-level cell (TLC) mode. The second mode is not limited to pSLC mode, and may be single-level cell (SLC) mode.

### Appendices

Technical ideas that can be comprehended from the above embodiment and modifications will be described.

### Appendix 1

A control device for controlling an information storage device that is configured to store a plurality of bits of information in one cell, in which a mode of the information storage device is switched to a second mode in which one bit of information is stored in one cell, on condition that a count of times that information is storable in the information storage device is smaller than a predetermined count of times, when the information storage device is in a first mode in which multiple bits of information are stored in one cell.

### Appendix 2

The control device according to Appendix 1, in which the mode of the information storage device is switched to the second mode, on condition that the count of times that information is storable in the information storage device is smaller than the predetermined count of times and also a remaining capacity of the information storage device that is available is no smaller than a predetermined capacity, when the information storage device is in the first mode.

### Appendix 3

The control device for an information storage device according to Appendix 1 or 2, in which predetermined information stored in the information storage device is deleted, when the count of times that information is storable in the information storage device is smaller than the predetermined count of times and also the remaining capacity of the information storage device that is available is smaller than the predetermined capacity, when the information storage device is in the first mode.

### Appendix 4

The control device according to Appendix 3, in which, following deleting the predetermined information, whether the remaining capacity of the information storage device that is available is smaller than the predetermined capacity is determined.

### Appendix 5

The control device according to any one of Appendices 1 to 4, in which, information indicating a request to delete information stored in the information storage device is output, to an output device, when the count of times that information is storable in the information storage device is smaller than the predetermined count of times and also the remaining capacity of the information storage device that is available is smaller than the predetermined capacity, when the information storage device is in the first mode.

### Appendix 6

The control device according to Appendix 5, in which, following outputting information, indicating a request to delete information stored in the information storage device, to the output device, whether the remaining capacity of the information storage device that is available is smaller than the predetermined capacity is determined when information stored in the information storage device is deleted by an operation from an input device.

### Appendix 7

A non-transitory storage medium storing instructions that are executable by one or more processors and that cause the one or more processors to perform functions comprising switching an information storage device configured to store a plurality of bits of information in one cell to a second mode on condition that a count of times that information is storable in the information storage device is smaller than a predetermined count of times, when the information storage device is in a first mode, in which the first mode is a mode in which multiple bits of information are stored in one cell, and the second mode is a mode in which one bit of information is stored in one cell.

What is claimed is:

1. A control device configured to control an information storage device that is configured to store a plurality of bits of information in one cell, the control device comprising an execution unit configured to switch the information storage device to a second mode, on condition that a count of times that information is storable in the information storage device is smaller than a predetermined count of times, when the information storage device is in a first mode, wherein:
the first mode is a mode in which multiple bits of information are stored in one cell; and
the second mode is a mode in which one bit of information is stored in one cell.

2. The control device according to claim 1, wherein the execution unit is configured to switch the information storage device to the second mode, on condition that the count of times that information is storable in the information storage device is smaller than the predetermined count of times and also a remaining capacity of the information storage device that is available is no smaller than a predetermined capacity, when the information storage device is in the first mode.

3. The control device according to claim 2, wherein the execution unit is configured to delete predetermined information stored in the information storage device, on condition that the count of times that information is storable in the information storage device is smaller than the predetermined count of times and also the remaining capacity of the information storage device that is available is smaller than the predetermined capacity, when the information storage device is in the first mode.

4. The control device according to claim 3, wherein the execution unit is configured to, following deleting the predetermined information, determine whether the remaining capacity of the information storage device that is available is smaller than the predetermined capacity.

5. The control device according to claim 2, wherein the execution unit is configured to output, to an output device, first information indicating a request to delete information stored in the information storage device, on condition that the count of times that information is storable in the information storage device is smaller than the predetermined count of times and also the remaining capacity of the information storage device that is available is smaller than the predetermined capacity, when the information storage device is in the first mode.

6. The control device according to claim 5, wherein the execution unit is configured to, following outputting the first information to the output device, determine whether the remaining capacity of the information storage device that is available is smaller than the predetermined capacity when information stored in the information storage device is deleted by an operation from an input device.

7. The control device according to claim 1, wherein:
the information storage device includes a plurality of regions for storing information; and
the execution unit is configured to switch storage modes of the regions individually.

8. An information processing device comprising:
an information storage device configured to store a plurality of bits of information in one cell; and
a control device configured to control the information storage device, wherein:
the control device includes an execution unit and a storage unit;
the storage unit is configured to store an operating system and an application that runs on the operating system;
the execution unit is configured to
store information in the information storage device in conjunction with execution of the application running on the operating system, and
switch a storage mode of the information storage device to a second mode, on condition that a count of times that information is storable in the information storage device is smaller than a predetermined count of times, when the storage mode of the information storage device is a first mode at a time of updating the operating system;
the first mode is a mode in which multiple bits of information are stored in one cell; and
the second mode is a mode in which one bit of information is stored in one cell.

9. The information processing device according to claim 8, wherein:
the information processing device is installed in a vehicle;
the operating system is a first operating system, and a region of the information processing device that stores information in conjunction with execution of a first application running on the first operating system is a first region;
the first application is a program that performs control different from traveling control of the vehicle; and
the execution unit is configured to switch the first region to the second mode, on condition that a count of times that information is storable in the first region of the information storage device is smaller than a predetermined count of times, when the first region is in the first mode at a time of updating the first operating system.

10. The information processing device according to claim 9, wherein:
the storage unit is configured to store a second operating system different from the first operating system and a second application running on the second operating system;
the second application is a program that performs traveling control of the vehicle; and
the control device is configured to
store information in a second region of the information storage device that is different from the first region, in conjunction with execution of the second application, and
switch the first region to the second mode without switching the second region to the second mode, on condition that the count of times that information is storable in the first region of the information storage device is smaller than the predetermined count of times, when the first region is in the first mode at the time of updating the first operating system.

11. A control method for controlling an information storage device that is configured to store a plurality of bits of information in one cell, the control method being executed by a computer and comprising switching the information storage device to a second mode on condition that a count of times that information is storable in the information storage device is smaller than a predetermined count of times, when the information storage device is in a first mode, wherein:
the first mode is a mode in which multiple bits of information are stored in one cell; and
the second mode is a mode in which one bit of information is stored in one cell.
